(19) United States
(12) Patent Application Publication
(10) Pub. No.: US 2026/0153241 A1
(43) Pub. Date: Jun. 4, 2026

(54) INTELLIGENT NETWORKED RANGE HOOD

(71) Applicant: Microjet Technology Co., Ltd., Hsinchu (TW)

(72) Inventors: Hao-Jan Mou, Hsinchu (TW); Chin-Chuan Wu, Hsinchu (TW); Chi-Feng Huang, Hsinchu (TW)

(73) Assignee: Microjet Technology Co., Ltd., Hsinchu (TW)

(21) Appl. No.: 19/018,519

(22) Filed: Jan. 13, 2025

(30) Foreign Application Priority Data
Nov. 29, 2024 (TW) 113146225
Dec. 13, 2024 (TW) 113148808

(51) Int. Cl. F24C 15/20; H04W 4/33

(52) U.S. Cl. CPC F24C 15/2021; H04W 4/33

(57) ABSTRACT

An intelligent networked range hood is disclosed and includes a main body, an air guiding fan, a host driving controller and a gas detection module. The main body has an air suction port and an air hood frame, and the air suction port communicates with an air guiding path of a duct. The air guiding fan is disposed in the duct for guiding air to exhaust. The host driving controller controls activation operation of the air hood frame and dynamically adjusts an operating frequency and an output air volume of the air guiding fan. The gas detection module is electrically connected to the host driving controller, and configured to detect air pollution to generate a detection data, and the detection data is transmitted to a networked cloud computing service device through IoT communication. The networked cloud computing service device real-timely controls the host driving controller to control the activation operation of the air hood frame and dynamically adjust operating frequency and output air volume of the fan.

### CROSS-REFERENCE TO RELATED APPLICATION

This application claims priorities to Taiwan Patent Application No. 113146225, filed on Nov. 29, 2024 and Taiwan Patent Application No. 113148808, filed on Dec. 13, 2024. The entire contents of the above-mentioned patent applications are incorporated herein by reference for all purposes.

### FIELD OF THE INVENTION

The present disclosure relates to a kitchen oil smoke treatment technology, and more particularly to an intelligent networked range hood capable of automatic detection, intelligence and remote control, which is for real-time cleaning kitchen oil smoke and enhancing air quality.

### BACKGROUND OF THE INVENTION

Traditional range hoods usually lack air quality monitoring and automatic purification functions, and cannot deal with more comprehensive air pollution problems. The inability to automatically adjust the wind speed or operating mode in response to cooking conditions makes it difficult to achieve the optimal smoke removal effect. With the rise of the smart home technology, the demand for automatic and intelligent functions of range hoods is becoming increasingly intense. Therefore, the present disclosure aims to solve the problem and provides an intelligent networked range hood capable of real-time detecting the concentration of oil smoke, automatically adjusting suction force, reducing unnecessary energy consumption, and supporting cloud connection. Furthermore, automation and optimization of intelligent operations are achieved, and the kitchen oil smoke is real-time purified and completely cleaned, and the indoor ambient air quality is regulated and maintained at the optimal state in a modern home environment.

### SUMMARY OF THE INVENTION

One object of the present disclosure is to provide an intelligent networked range hood, which includes a built-in gas detection module for detecting air pollution in real time. In addition, the gas detection module has cloud connection capabilities, which facilitates remote monitoring and operation by users. Moreover, the air pollution detection data is transmitted to a networked cloud computing service device through IoT communication (wireless communication or wired communication), the networked cloud computing service device intelligently selects a control command based on the collection and analysis of the detection data monitored real-time, and the control command is transmitted to the gas detection module to control activation operation of the air guiding fan and dynamically adjust the efficiency of operating frequency and output air volume of the air guiding fan. It can not only detect the concentration of oil smoke in real time and automatically adjust suction force, but also reduce unnecessary energy consumption. Furthermore, automation and optimization of operations are achieved, and the kitchen oil smoke is real-time purified and completely cleaned, and the indoor ambient air quality is regulated and maintained at the optimal state in a modern home environment.

In accordance with an aspect of the present disclosure, an intelligent networked range hood is provided and includes a main body, at least one air guiding fan, at least one host driving controller and at least one gas detection module. The main body includes at least one air suction port, a duct and an air hood frame, wherein the at least one air suction port is in communication with an air guiding path of the duct. The at least one air guiding fan is disposed in the duct for guiding air pollution of a cooking area to the duct and discharging to the outdoor field. The at least one host driving controller control activation operation of the air hood frame, and dynamically adjusts an operating frequency and an output air volume of the at least one air guiding fan. The at least one gas detection module is electrically connected to the at least one host driving controller, and detects a humidity, a temperature and the air pollution in the air to output a detection data, and transmitted the detection data to a networked cloud computing service device through IoT communication. Wherein, the networked cloud computing service device adjusts and controls the at least one host driving controller in real time to regulates the activation operation of the air hood frame and dynamically adjusts the operating frequency and the output air volume of the at least one air guiding fan according to the detection data.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A is a schematic perspective view illustrating an intelligent networked range hood according to a first embodiment of the present disclosure;

FIG. 1B is a schematic cross-sectional view illustrating related components in the intelligent networked range hood according to the first embodiment of the present disclosure;

FIG. 1C is a schematic cross-sectional view illustrating an air hood frame of the intelligent networked range hood according to the first embodiment of the present disclosure;

FIG. 1D is a schematic perspective view illustrating the actions of blocking oil smoke without spreading and concentrating suction by the collaboration of an air hood frame and extended baffles pivotally connecting to deflectors of an intelligent networked range hood according to a second embodiment of the present disclosure;

FIG. 1E is a schematic perspective view illustrating the actions of blocking oil smoke without spreading and concentrating suction by the collaboration of an air hood frame and extended baffles extended downward from the inside of the deflectors of an intelligent networked range hood according to a third embodiment of the present disclosure;

FIG. 1F is a schematic perspective view illustrating the actions of blocking oil smoke without spreading and concentrating suction by the collaboration of an air hood frame and a extended baffle pulled forward from deflectors of an intelligent networked range hood according to a fourth embodiment of the present disclosure;

FIG. 1G is a schematic perspective view illustrating the actions of blocking oil smoke without spreading and concentrating suction by the collaboration of an air hood frame and deflectors pulled forward and a extended baffle pulled forward and laterally of an intelligent networked range hood according to a fifth embodiment of the present disclosure;

FIG. 1H is a schematic perspective view illustrating an air guiding fan maintains a sound insulation distance from the an air suction port of the intelligent networked range hood according to the first embodiment of the present disclosure;

FIG. 1I is a schematic perspective view illustrating related positions of the air suction ports respectively located on a lateral side and a surface of the top of the intelligent networked range hood according to the first embodiment of the present disclosure;

FIG. 2 is a schematic cross-sectional view illustrating a filtering component according to the first embodiment of the present disclosure;

FIG. 3 is a schematic diagram illustrating the architecture of a gas detection module of the intelligent networked range hood connected to a host driving controller and a networked cloud computing service device according to the first embodiment of the present disclosure;

FIG. 4A is a schematic perspective view (1) illustrating a gas detection main part of the gas detection module according to the first embodiment of the present disclosure;

FIG. 4B is another schematic perspective view (2) illustrating the gas detection main part of the gas detection module according to the first embodiment of the present disclosure;

FIG. 5 is an exploded view illustrating the gas detection main part of the gas detection module according to the embodiment of the first present disclosure;

FIG. 6A is a schematic perspective view (1) illustrating a base of the gas detection main part of the gas detection module according to the first embodiment of the present disclosure;

FIG. 6B is another schematic perspective view (2) illustrating the base of the gas detection main part of the gas detection module according to the first embodiment of the present disclosure;

FIG. 6C is a schematic view (3) illustrating the base combined with a laser component and a piezoelectric actuator separated from the base of the gas detection main part of the gas detection module according to the first embodiment of the present disclosure;

FIG. 7 a schematic perspective view illustrating the combination of the piezoelectric actuator and the base of the gas detection main part of the gas detection module according to the first embodiment of the present disclosure;

FIG. 8A is a schematic exploded view (1) illustrating the piezoelectric actuator of the gas detection main part of the gas detection module according to the first embodiment of the present disclosure;

FIG. 8B is another schematic exploded view (2) illustrating the piezoelectric actuator of the gas detection main part of the gas detection module according to the first embodiment of the present disclosure;

FIG. 9A is a schematic cross-sectional view (1) illustrating an action of the piezoelectric actuator of the gas detection main part of the gas detection module according to first the embodiment of the present disclosure;

FIG. 9B is a schematic cross-sectional view (2) illustrating an action of the piezoelectric actuator of the gas detection main part of the gas detection module according to the first embodiment of the present disclosure;

FIG. 9C is a schematic cross-sectional view (3) illustrating an action of the piezoelectric actuator of the gas detection main part of the gas detection module according to the first embodiment of the present disclosure;

FIG. 10A is a schematic cross-sectional view (1) illustrating the gas detection main part of the gas detection module introducing gas according to the first embodiment of the present disclosure;

FIG. 10B is a schematic cross-sectional view (2) illustrating the gas detection main part of the gas detection module detecting gas according to the first embodiment of the present disclosure;

FIG. 10C is a schematic cross-sectional view (3) illustrating the gas detection main part of the gas detection module exhausting gas according to the first embodiment of the present disclosure; and

FIG. 11 is a schematic diagram illustrating the architecture of the networked cloud computing service device according to the first embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

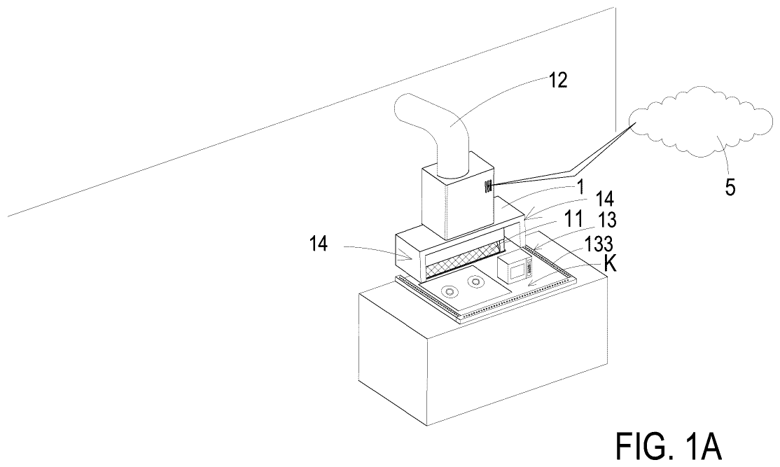

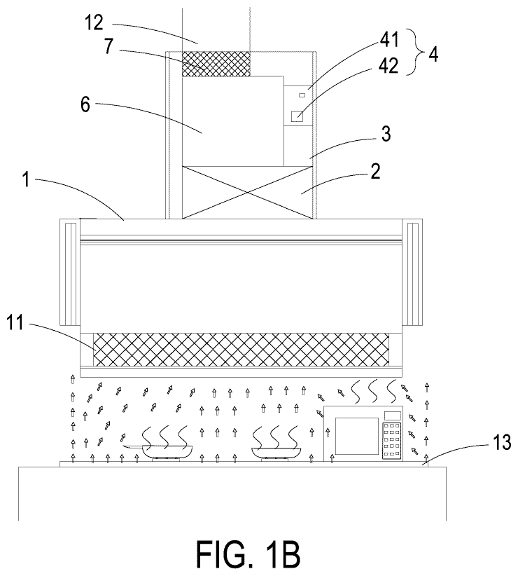

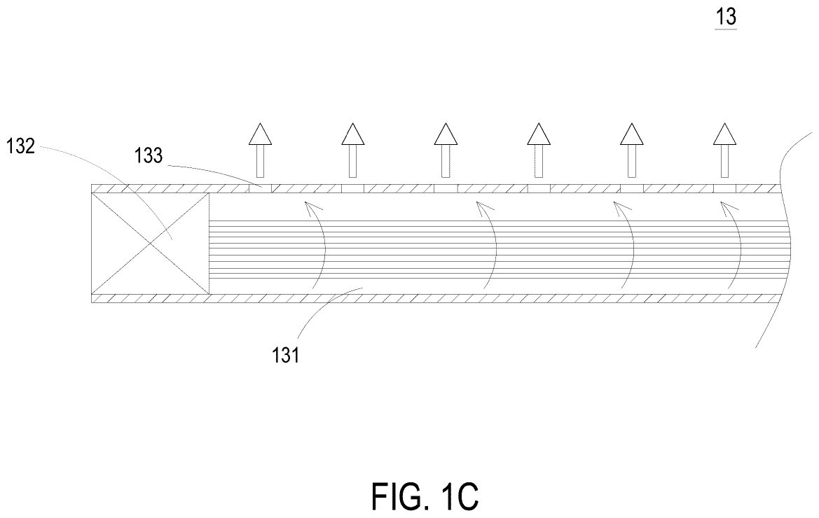

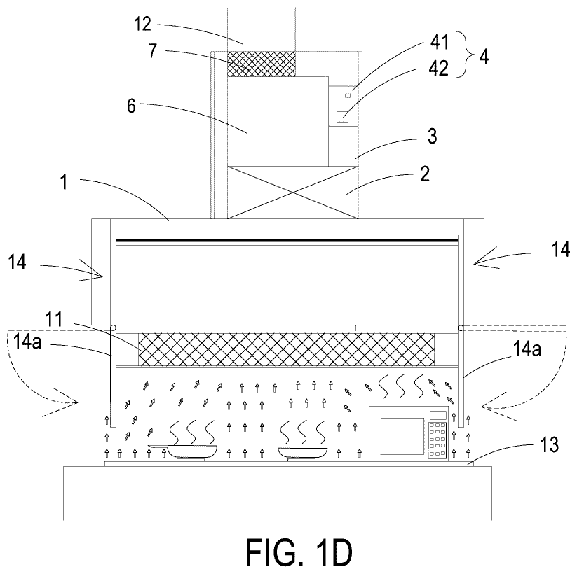

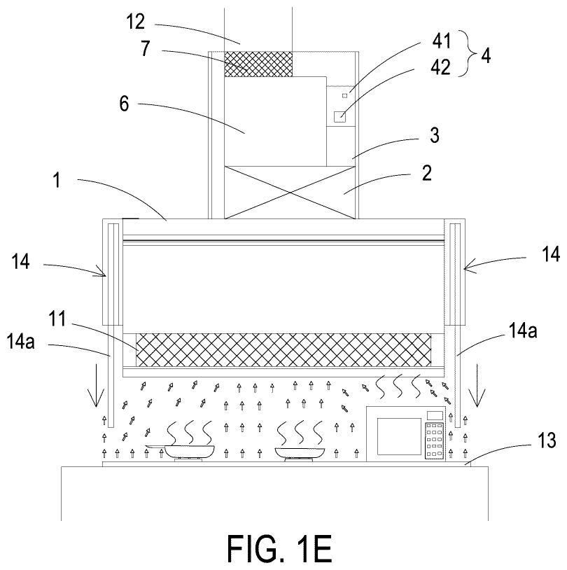

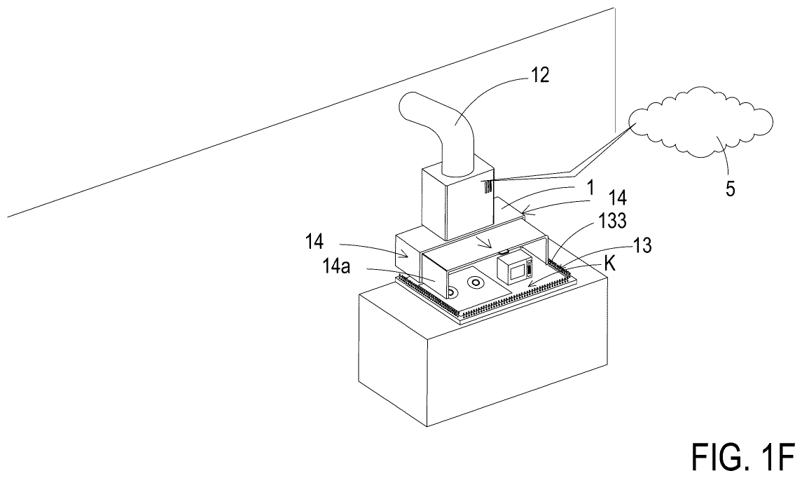

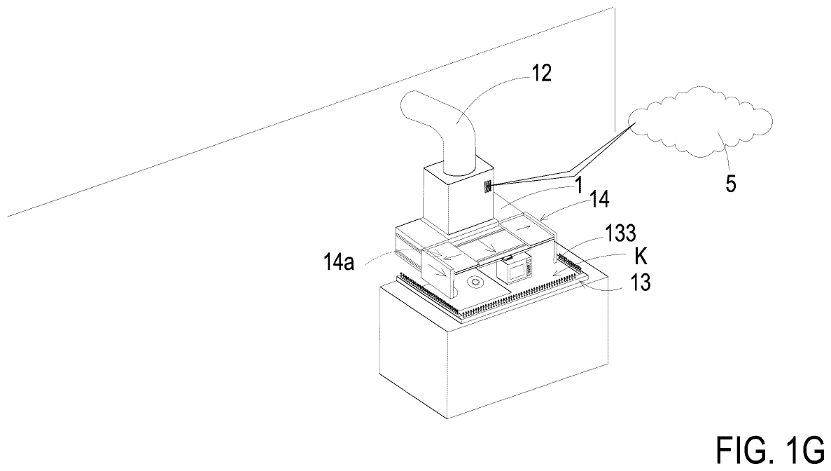

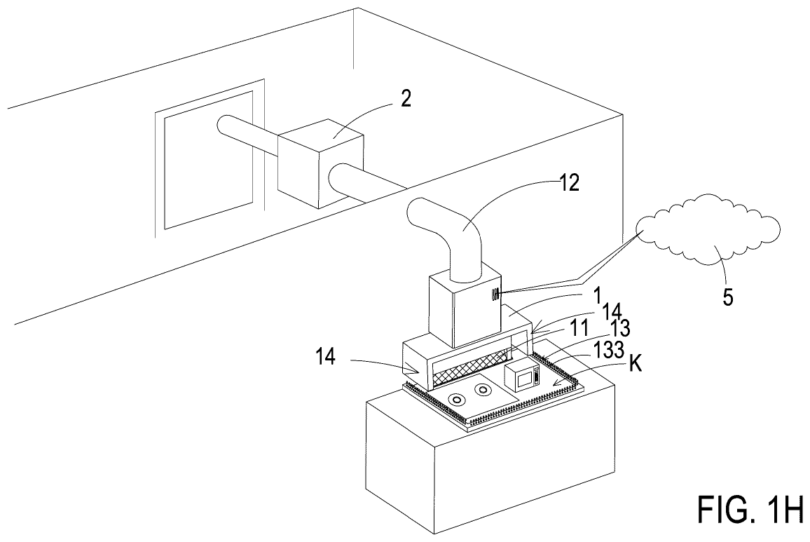

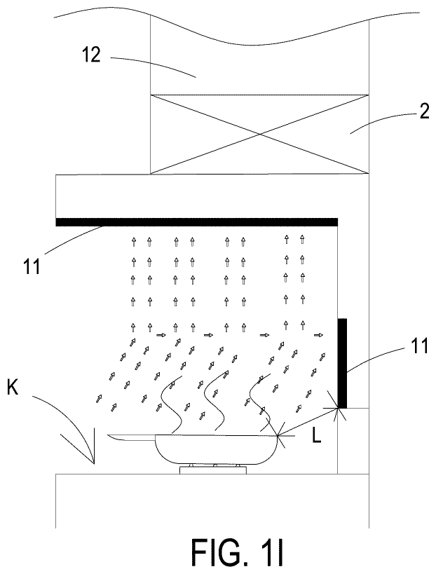

Please refer to FIG. 1A and FIG. 1B. The present disclosure provides an intelligent networked range hood includes a main body 1, at least one air guiding fan 2, a host driving controller 3 and at least one gas detection module 4. The at least one air guiding fan is disposed in the duct 12 for guiding air pollution to flow into the duct 12 and be discharged to the outdoor field. It is worth noting that in the embodiment of the drawings, there is one air guiding fan 2 and one gas detection module 4, but the present disclosure is not limited thereto.

Please refer to FIG. 1A to FIG. 1I. In the embodiment, the main body 1 includes an air suction port 11 and a duct 12, wherein the air suction port 11 is in communication with an air guiding path of the duct 12. It is worth noting that in some embodiments, the air suction port 11 is disposed on a lateral side of the main body 1 against a wall and is in communication with the duct 12. As shown in FIG. 1I, the distance L between the air suction port 11 and a pot of the cooking area K is ranged from 20 cm to 30 cm, but not limited thereto. In some embodiments, the air suction port 11 is disposed on a surface of the top of the main body 1 and is in communication with the duct 12. In other embodiments, as shown in FIG. 1I, there are two air suction ports 11, one air suction port 11 is disposed on the lateral side of the main body 1 against a wall and is in communication with the duct 12. The distance L between the air suction port 11 and the pot of the cooking area K is ranged from 20 cm to 30 cm. Another air suction port 11 is disposed on a surface of the top of the main body 1 and is also in communication with the duct 12. Consequently, the air pollution in the cooking area is guided to the duct 12 through these air suction ports 11 by the air guiding fan 2 and discharged to the outdoor field.

Please refer to FIG. 1A and FIG. 1B. In this embodiment, the intelligent networked range hood further includes an air hood frame 13. The air hood frame 13 is disposed around the cooking area K, wherein the air hood frame 13 is activated by the at host driving controller 3 to generate an upward air flow with pressure around the cooking area K. Consequently, the air pollution of cooking is blocked in the cooking area K without spreading, and is concentrated into the duct 12 by passing through the air guiding path, so as to discharge to the outdoor field.

Please refer to FIG. 1C. In the embodiment, the air hood frame 13 includes an air guiding passage 131, and a fan 132 is arranged in the air guiding passage 131 to introduce an external gas. As shown in FIG. 1C, a plurality of fumaroles 133 are disposed above the air guiding passage 131. When the fan 132 is activated, the gas in the air guiding passage 131 is discharged through the plurality of fumaroles 133 to generate the upward airflow with pressure around the cooking area K. Consequently, the air pollution of cooking is blocked in the cooking area K without spreading, and is concentrated into the duct 12 by passing through the air guiding path, and then discharged to the outdoor field through the fan 2, so that the air pollution is purified and completely cleaned. It is worth noting that in the embodiment, the fan 132 can be an armature fan or a centrifugal fan, but not limited thereto. In other words, any fan 132 that can generate airflow can be regarded as an extension of the present embodiment.

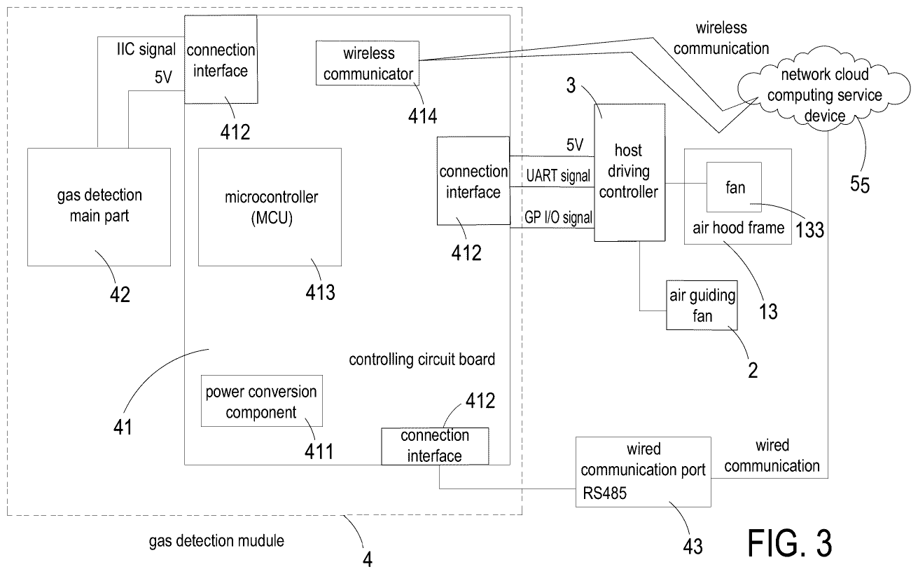

Please refer to FIG. 3. In the embodiment, the host driving controller 3 controls activation operation of the air guiding fan 2, and dynamically adjusting an operating frequency and an output air volume of the air guiding fan 2. Moreover, the gas detection module 4 is electrically connected to the host driving controller 3 for controlling. The gas detection module 4 is configured to detect humidity, temperature and air pollution to generate a detection data. The detection data is transmitted to a networked cloud computing service device 5 through IoT communication. The networked cloud computing service device 5 real-timely regulates the host driving controller 3 according to the detection data, so as to control the activation operation of the air guiding fan 2, and dynamically adjust the operating frequency and the output air volume of the air guiding fan 2.

Please refer to FIG. 3 again. In the embodiment, the gas detection module 4 includes a controlling circuit board 41 and a gas detection main part 42. The gas detection main part 42 detects the humidity, the temperature and the air pollution to generate the detection data. The controlling circuit board 41 collects, calculates, analyzes and outputs the detection data to form a serial communication (IIC) signal for input, and the networked cloud computing service device 5 receives and analyzes the detection data in real time to output a Universal Asynchronous Transceiver and Transceiver (UART) signal and a General Purpose Input and Output (GP I/O) signal for the host driving controller 3. In the embodiment, the controlling circuit board 41 is embedded on the top surface of the main body 1 and is electrically connected to the host driving controller 3 for control. Moreover, the controlling circuit board 41 is signally connected to external components or devices through at least one connection interface 412. In the embodiment, the controlling circuit board 41 includes a plurality of connection interfaces 412, and the plurality of connection interfaces 412 are connected to the gas detection main part 42, the host driving controller 3 and a wired communication port 43, respectively for signal connection. Certainly, the present disclosure is not limited thereto. In an embodiment, the controlling circuit board 41 can select one connection interface 412 to connect with the gas detection main part 42, the host driving controller 3 and a wired communication port 43, respectively for signal connection. In the embodiment, the controlling circuit board 41 includes a power conversion component 411, a microcontroller (MCU) 413 and a wireless communicator 414. The power conversion component 411 provides DC voltage division modulation to output a required DC voltage. The required DC voltage is transmitted through at least one connection interface 412 to the gas detection main part 42 for actuation operation and to the host driving controller 3 for actuation operation. The microcontroller (MCU) 413 is connected to the gas detection main part 42 through the at least one connection interface 412 to form the serial communication (IIC) signal for input, so that the detection data is calculated and analyzed, and connected through the at least one connection interface 412 to output the Universal Asynchronous Transceiver and Transceiver (UART) signal and the General Purpose Input and Output (GP I/O) signal for regulation of the host driving controller 3. The wireless communicator 414 receives the detection data and transmits the detection data to the networked cloud computing service device 5 through external wireless communication. The networked cloud computing service device 5 collects, analyzes and monitors the detection data in real time and intelligently selects a control command, and the control command is received through the wireless communicator 414 and transmitted to the microcontroller (MCU) 413 to output the Universal Asynchronous Transceiver and Transceiver (UART) signal and the General Purpose Input and Output (GP I/O) signal for regulation of the host driving controller 3, so that the host driving controller 3 is regulated to control the activation operation of the at least one air guiding fan, 2 and dynamically adjust the operating frequency and the output air volume of the at least one air guiding fan 2. In an embodiment, the intelligent networked range hood further includes a wired communication port 43. The wired communication port 43 is electrically connected to the controlling circuit board 41 through a connection interface 412 for external connection to a wired communication transmission. The detection data is received and transmitted to the networked cloud computing service device 5 through external wireless communication, the networked cloud computing service device 5 collects, analyzes and monitors the detection data in real time and intelligently selects a control command, and the control command is received through the wired communication port 43 and transmitted to the microcontroller (MCU) 413 to output the Universal Asynchronous Transceiver and Transceiver (UART) signal and the General Purpose Input and Output (GP I/O) signal for regulation of the host driving controller 3, so that the host driving controller 3 is regulated to control the activation operation of the at least one air guiding fan 2, and dynamically adjust the operating frequency and the output air volume of the at least one air guiding fan 2. Notably, in the embodiment, the wired communication port 43 is an RS485 port that communicates with the networked cloud computing service device 5 through a wired line connection.

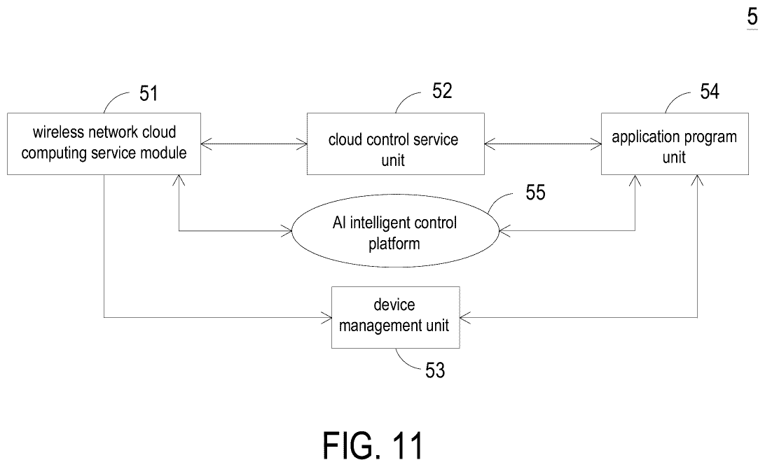

Moreover, as shown in FIG. 11, the networked cloud computing service device 5 includes a wireless network cloud computing service module 51, a cloud control service unit 52, a device management unit 53, an application program unit 54 and an AI intelligent control platform 55. In the embodiment, the wireless network cloud computing service module 51 receives the information of the air pollution data from the gas detection module 4 of the intelligent networked range hood, and transmits the control commands. Moreover, the wireless network cloud computing service module 51 receives the information of the air pollution data and transmits the information to the cloud control service unit 52 to store and form the big data database of the air pollution data. An artificial intelligence calculation is implemented to determine the location of the air pollution through the air pollution database comparison, so that the control command is transmitted to the wireless network cloud computing service module 51, and then transmitted to the gas detection module 4 of the intelligent networked range hood to control the actuation operation through the wireless network cloud computing service module 51. The device management unit 53 receives the communication information of the gas detection module 4 of the intelligent networked range hood through the wireless network cloud computing service module 51 to manage the user login and device binding. It can also provide maintenance, management, automatic abnormal point detection, analysis, processing and improvement of intelligent networked range hood. Management information, such as controlling inspection and measurement compliance with cleanliness requirements, customer demand feedback, and correction mechanisms for software and hardware technology improvements, is provided to the application unit for system control and management. Furthermore, the device management information can be provided to the application program unit 54 for system control and management, and the application program unit 54 can also display and inform the air pollution information obtained by the cloud control service unit 52. The user can know the real-time status of air pollution removal through the mobile phone or the communication device. Moreover, the user can control the operation of the indoor air cleaning network mechanism intelligent system through the application program unit 54 of the mobile phone or the communication device. In addition, the AI intelligent control platform 55 collects, analyzes and monitors the detection data in real time, intelligently selects and generates a control instruction, and transmits the control instruction to the at least one gas detection module 4 for receiving. In that, the host driving controller 3 is used to control the activation operation of the at least one air guiding fan 2, and dynamically adjust the operating frequency and the output air volume of the air guiding fan 2. That is to say, the control command issued by intelligent judgment is sent to the host driving controller 3 to control the activation operation of the air guiding fan 2 and dynamically adjust the operating frequency and the output air volume of the air guiding fan 2. As the gas detection data is greater than the safety detection value, the output air volume of the air guiding fan 2 is adjusted to be larger, and the air guide fan 2 is automatically started to strengthen the purification mode. As the gas detection data is close to the safety detection value, the output air volume of the air guiding fan 2 is adjusted to be smaller. According to the collection and analysis of real-time monitoring detection data, the operating frequency of the air guiding fan 2 is dynamically adjusted. It can be automatically switched to a low energy consumption mode, so as to reduce airflow noise. Even when the air quality in the indoor area is cleaned completely, the operation will be stopped to reduce unnecessary energy consumption.

From the above descriptions, the present disclosure provides an intelligent networked range hood including the built-in gas detection module 4 with the cloud connection capabilities to be implemented in the intelligent system of indoor air purification network mechanism. All air pollution detection data can be uploaded to the networked cloud computing service device 5, so that the intelligent networked range hood can real-time detect the concentration of oil smoke of the cooking area K and monitor the activation state of the air guiding fan 2. As shown in FIG. 1B, when the guiding fan 2 is activated, through the collaboration of the upward air flow with pressure around the cooking area K generated from the air hood frame 13 and the two deflectors 14 arranged in the two side of the main body 1, the air pollution of cooking in the cooking area K can be blocked in the cooking area K without spreading, and is concentrated to the duct 12 by passing through the air guiding path, and then discharged to the outdoor field through the guiding fan 2, so that the air pollution is purified and completely cleaned. Consequently, the intelligent networked range hood can use the networked cloud intelligent control of the gas detection module 4 to real-time monitor the activation state and dynamically adjust the efficiency of operating frequency and output air volume of the air guiding fan 2. It can not only automatically adjust suction force, but also reduce unnecessary energy consumption. Furthermore, automation and optimization of operations are achieved, and the kitchen oil smoke is real-time purified and completely cleaned, and the indoor ambient air quality is regulated and maintained at the optimal state in a modern home environment.

After understanding the overall structure of the intelligent networked range hood of the present disclosure, the detailed structure of the gas detection main part 42 of the gas detection module 4 will be described in detail below.

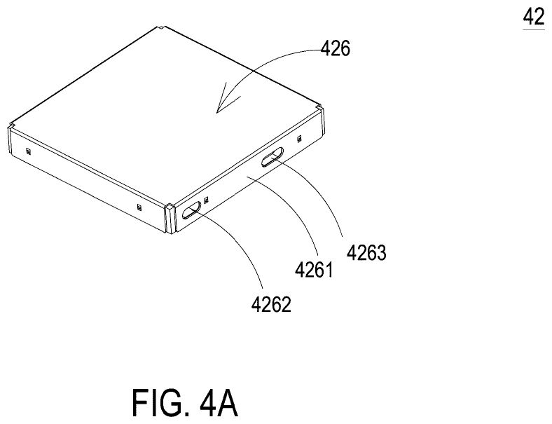

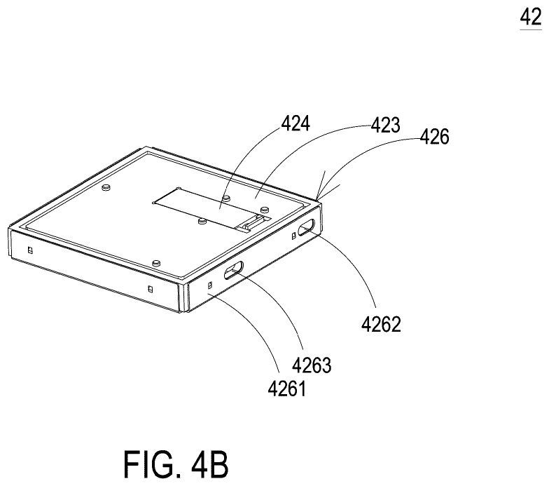

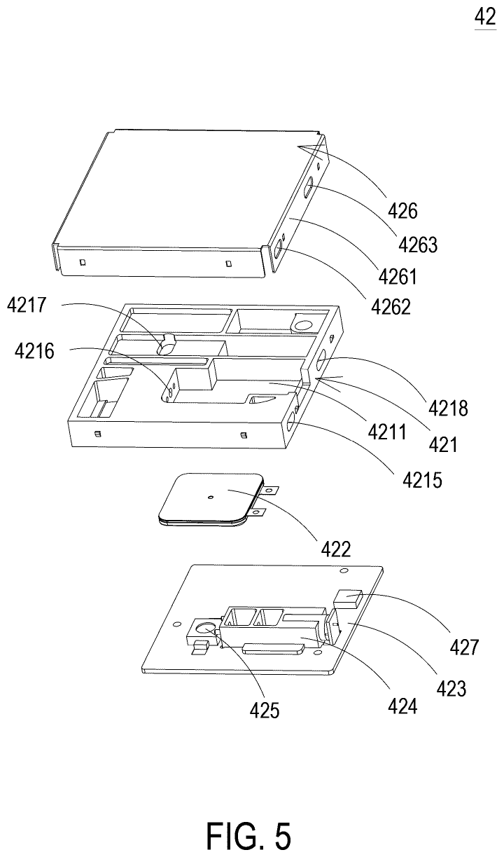

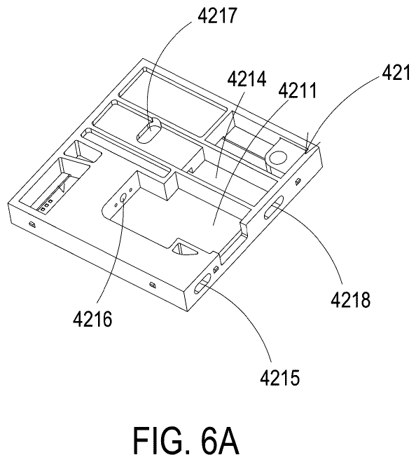

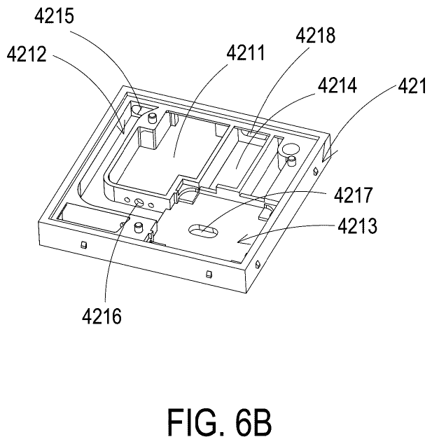

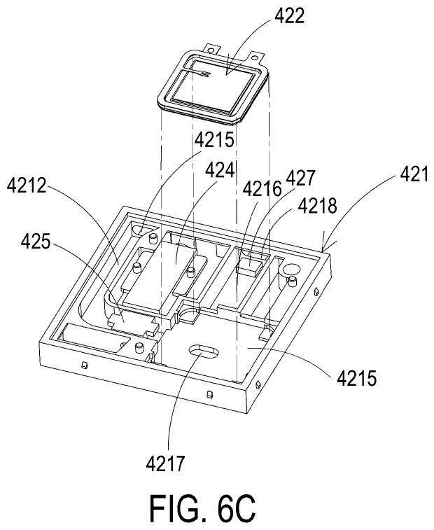

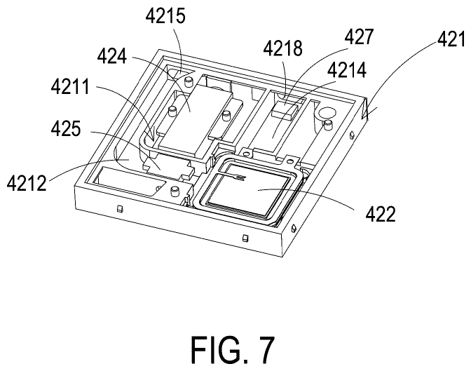

Please refer to FIG. 4A, FIG. 4B, FIG. 5, FIG. 6A to FIG. 6C and FIG. 7. In the embodiment, the gas detection main part 42 includes a base 421, a piezoelectric actuator 422, a driving circuit board 423, a laser component 424, a particulate sensor 425, an outer cover 426 and a gas sensor 427.

In the embodiment, the base 421 includes a laser loading region 4211, a gas-inlet groove 4212, a gas-guiding-component loading region 4213 and a gas-outlet groove 4214. The gas-inlet groove 4212 includes a gas-inlet 4215 and two lateral walls, the gas-inlet 4215 is in communication with an environment outside the base, and a transparent window 4216 is opened on the two lateral walls and is in communication with the laser loading region 4211. The gas-guiding-component loading region 4213 is in communication with the gas-inlet groove 4212, and a ventilation hole 4217 penetrates a bottom surface of the gas-guiding-component loading region 4213. The gas-outlet groove 4214 is in communication with the ventilation hole 4217, and a gas-outlet 4218 is disposed in the gas-outlet groove 4214. In the embodiment, the outer cover 426 covers the base 421, and includes a side plate 4261. The side plate 4261 has an inlet opening 4262 and an outlet opening 4263. The inlet opening 4262 is spatially corresponding to the gas-inlet 4215 of the base 421, and the outlet opening 4263 is spatially corresponding to the gas-outlet 4218 of the base 421.

In the embodiment, the laser component 424, the particulate sensor 425 and the gas sensor 427 are disposed on and electrically connected to the driving circuit board 423 and located within the base 421. In order to clearly describe and illustrate the positions of the laser component 424 and the particulate sensor 425 in the base 421, the driving circuit board 423 is intentionally omitted. The laser component 424 is accommodated in the laser loading region 4211 of the base 421, and the particulate sensor 425 is accommodated in the gas-inlet groove 4212 of the base 421 and is aligned to the laser component 424. In addition, the laser component 424 is spatially corresponding to the transparent window 4216, therefore, a light beam emitted by the laser component 424 passes through the transparent window 4216 and is irradiated into the gas-inlet groove 4212. A light beam path emitted from the laser component 424 passes through the transparent window 4216 and extends in an orthogonal direction perpendicular to the gas-inlet groove 4212. In the embodiment, a projecting light beam emitted from the laser component 424 passes through the transparent window 4216 and enters the gas-inlet groove 4212 to irradiate the suspended particles contained in the gas passing through the gas-inlet groove 4212. When the suspended particles contained in the gas are irradiated and generate scattered light spots, the scattered light spots are received and calculated by the particulate sensor 425 in the orthogonal direction to obtain the gas detection data. Notably, the laser component 424 emits a parallel light source, and the parallel light source passes through the transparent window 4216.

In the embodiment, the gas sensor 427 is positioned and accommodated in the gas-outlet groove 4214, so as to detect the air pollution introduced into the gas-outlet groove 4214. Preferably but not exclusively, the particulate sensor 425 detects suspended particulate and outputs the detection data. Moreover, the gas sensor 427 includes a volatile-organic-compound sensor, and the volatile-organic-compound sensor detects gas of carbon dioxide (CO₂) or volatile organic compounds (TVOC) to output the detection data. In an embodiment, the gas sensor 427 is a formaldehyde sensor, and the formaldehyde sensor detects gas of formaldehyde (HCHO) to output the detection data. In an embodiment, the gas sensor 427 is a bacteria sensor, and the bacteria sensor detects gas information of bacteria or fungi to output the detection data. In an embodiment, the gas sensor 427 is a virus sensor, and the virus sensor detects gas of virus to output the detection data. In an embodiment, the gas sensor 427 is a temperature and humidity sensor, and the temperature and humidity sensor detects the temperature and humidity in air to output the detection data.

Please refer to FIG. 6C and FIG. 7. In the embodiment, the piezoelectric actuator 422 is accommodated in the gas-guiding-component loading region 4213 of the base 421. In addition, the gas-guiding-component loading region 4213 of the base 421 is in fluid communication with the gas-inlet groove 4212. When the driving circuit board 423 is covered inside the base 421 and the outer cover 426 is covered outside the base 421, the inlet opening 4262 corresponds to the gas-inlet 4215 of the base 421 to collaboratively define an inlet path, and the outlet opening 4263 corresponds to the gas-outlet 4218 of the base 421 to collaboratively define an air outlet path. When the piezoelectric actuator 422 is enabled, the gas in the gas-inlet groove 4212 is inhaled by the piezoelectric actuator 422, so that the gas flows into the piezoelectric actuator 422, and is transported into the gas-outlet groove 4214 through the ventilation hole 4217 of the gas-guiding-component loading region 4213. Finally, when the gas enters the gas-outlet groove 4214, the piezoelectric actuator 422 continuously transports the gas from the gas inlet path into the gas-outlet groove 4214, and the gas in the gas-outlet groove 4214 is pushed to the gas outlet path and through the gas-outlet 4218 and the outlet opening 4263 to discharge to the outside, to achieve the gas transportation at high speed and in large quantities.

After understanding the above structural description of the gas detection main part 42, the detailed structure of the piezoelectric actuator 422 will be described in detail below.

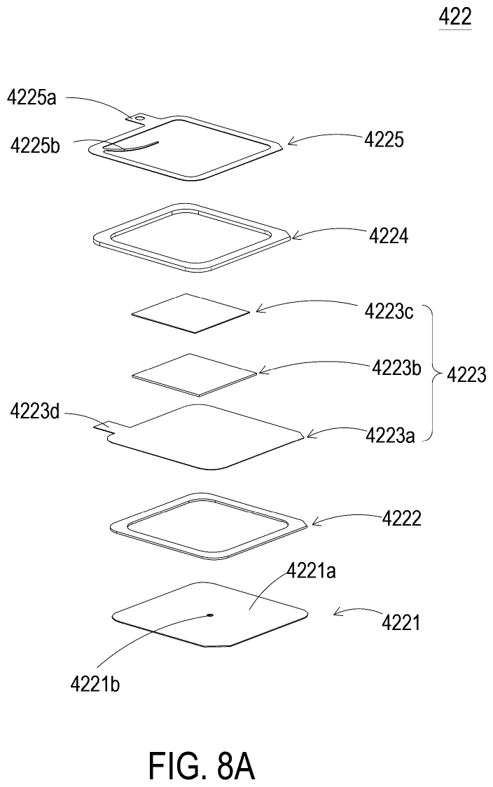

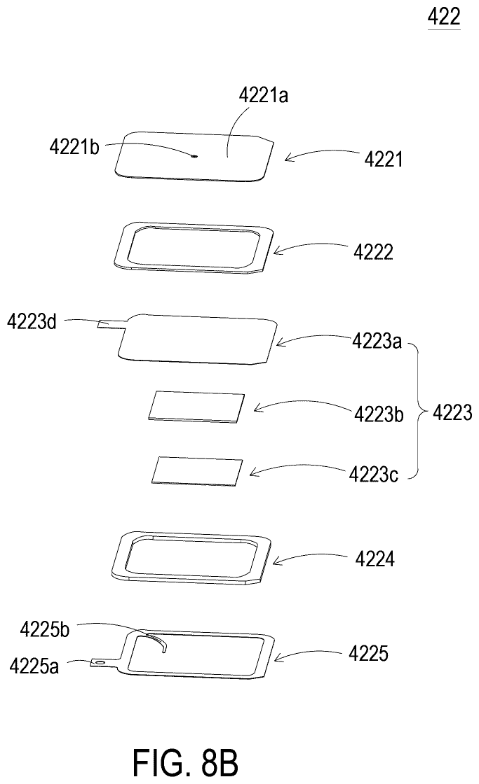

Please refer to FIG. 8A and FIG. 8B. In the embodiment, the piezoelectric actuator 422 includes a gas-injection plate 4221, a chamber frame 4222, an actuator element 4223, an insulation frame 4224 and a conductive frame 4225. In the embodiment, the gas-injection plate 4221 is made by a flexible material and includes a suspension plate 4221a and a hollow aperture 4221b. The suspension plate 4221a is a sheet structure and is permitted to undergo a bending deformation. Preferably but not exclusively, the shape and the size of the suspension plate 4221a are accommodated in the inner edge of the gas-guiding-component loading region 4215, but not limited thereto. The hollow aperture 4221b passes through a center of the suspension plate 4221a, so as to allow the gas to flow therethrough. Preferably but not exclusively, in the embodiment, the shape of the suspension plate 4221a is selected from the group consisting of a square, a circle, an ellipse, a triangle and a polygon, but not limited thereto.

In the embodiment, the chamber frame 4222 is carried and stacked on the gas-injection plate 4221. In addition, the shape of the chamber frame 4222 is corresponding to the gas-injection plate 4221. The actuator element 4223 is carried and stacked on the chamber frame 4222. A resonance chamber 4226 is collaboratively defined by the actuator element 4223, the chamber frame 4222 and the suspension plate 4221a and is formed between the actuator element 4223, the chamber frame 4222 and the suspension plate 4221a. The insulation frame 4224 is carried and stacked on the actuator element 4223 and the appearance of the insulation frame 4224 is similar to that of the chamber frame 4222. The conductive frame 4225 is carried and stacked on the insulation frame 4224, and the appearance of the conductive frame 4225 is similar to that of the insulation frame 4224. In addition, the conductive frame 4225 includes a conducting pin 4225a and a conducting electrode 4225b. The conducting pin 4225a is extended outwardly from an outer edge of the conductive frame 4225, and the conducting electrode 4225b is extended inwardly from an inner edge of the conductive frame 4225.

Moreover, the actuator element 4223 further includes a piezoelectric carrying plate 4223a, an adjusting resonance plate 4223b and a piezoelectric plate 4223c. The piezoelectric carrying plate 4223a is carried and stacked on the chamber frame 4222. The adjusting resonance plate 4223b is carried and stacked on the piezoelectric carrying plate 4223a. The piezoelectric plate 4223c is carried and stacked on the adjusting resonance plate 4223b. The adjusting resonance plate 4223b and the piezoelectric plate 4223c are accommodated in the insulation frame 4224. The conducting electrode 4225b of the conductive frame 4225 is electrically connected to the piezoelectric plate 4223c. In the embodiment, the piezoelectric carrying plate 4223a and the adjusting resonance plate 4223b are made by a conductive material. The piezoelectric carrying plate 4223a includes a piezoelectric pin 4223d. The piezoelectric pin 4223d and the conducting pin 4225a are electrically connected to a driving circuit (not shown) of the driving circuit board 423, so as to receive a driving signal, such as a driving frequency and a driving voltage. Through this structure, a circuit is formed by the piezoelectric pin 4223d, the piezoelectric carrying plate 4223a, the adjusting resonance plate 4223b, the piezoelectric plate 4223c, the conducting electrode 4225b, the conductive frame 4225 and the conducting pin 4225a for transmitting the driving signal. Moreover, the insulation frame 4224 is insulated between the conductive frame 4225 and the actuator element 4223, so as to avoid the occurrence of a short circuit. Thereby, the driving signal is transmitted to the piezoelectric plate 4223c. After receiving the driving signal such as the driving frequency and the driving voltage, the piezoelectric plate 4223c deforms due to the piezoelectric effect, and the piezoelectric carrying plate 4223a and the adjusting resonance plate 4223b are further driven to generate the bending deformation in the reciprocating manner.

Furthermore, in the embodiment, the adjusting resonance plate 4223b is located between the piezoelectric plate 4223c and the piezoelectric carrying plate 4223a and served as a cushion between the piezoelectric plate 4223c and the piezoelectric carrying plate 4223a. Thereby, the vibration frequency of the piezoelectric carrying plate 4223a is adjustable. Basically, the thickness of the adjusting resonance plate 4223b is greater than the thickness of the piezoelectric carrying plate 4223a, and the vibration frequency of the actuator element 4223 can be adjusted by adjusting the thickness of the adjusting resonance plate 4223b. In the embodiment, the gas-injection plate 4221, the chamber frame 4222, the actuator element 4223, the insulation frame 4224 and the conductive frame 4225 are stacked and positioned in the gas-guiding-component loading region 4213 sequentially, so that the piezoelectric actuator 422 is supported and positioned in the gas-guiding-component loading region 4213. A plurality of clearances 4221c are defined between the suspension plate 4221a of the gas-injection plate 4221 and an inner edge of the gas-guiding-component loading region 4213 for gas flowing therethrough.

In the embodiment, a flowing chamber 4227 is formed between the gas-injection plate 4221 and the bottom surface of the gas-guiding-component loading region 4213. The flowing chamber 4227 is in communication with the resonance chamber 4226 between the actuator element 4223, the gas-injection plate 4221 and the suspension plate 4221a. By controlling the vibration frequency of the gas in the resonance chamber 4226 to be close to the vibration frequency of the suspension plate 4221a, the Helmholtz resonance effect is generated between the resonance chamber 4226 and the suspension plate 4221a, so as to improve the efficiency of gas transportation. When the piezoelectric plate 4223c is moved away from the bottom surface of the gas-guiding-component loading region 4213, the suspension plate 4221a of the gas-injection plate 4221 is driven to move away from the bottom surface of the gas-guiding-component loading region 4213 by the piezoelectric plate 4223c. In that, the volume of the flowing chamber 4227 is expanded rapidly, the internal pressure of the flowing chamber 4227 is decreased to form a negative pressure, and the gas outside the piezoelectric actuator 422 is inhaled through the clearances 4221c and enters the resonance chamber 4226 through the hollow aperture 4221b. Consequently, the pressure in the resonance chamber 4226 is increased to generate a pressure gradient. When the suspension plate 4221a of the gas-injection plate 4221 is driven by the piezoelectric plate 4223c to move toward the bottom surface of the gas-guiding-component loading region 4213, the gas in the resonance chamber 4226 is discharged out rapidly through the hollow aperture 4221b, and the gas in the flowing chamber 4227 is compressed, thereby the converged gas is quickly and massively ejected out of the flowing chamber 4227 under the condition close to an ideal gas state of the Benulli's law, and transported to the ventilation hole 4217 of the gas-guiding-component loading region 4213.

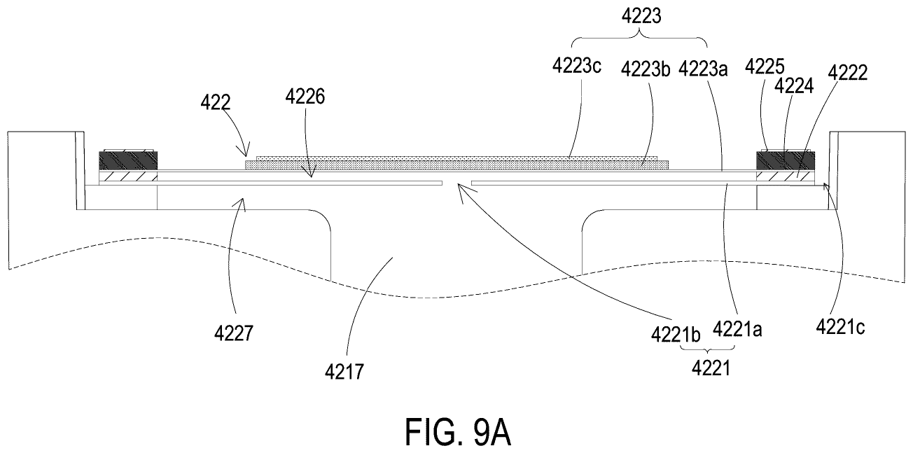

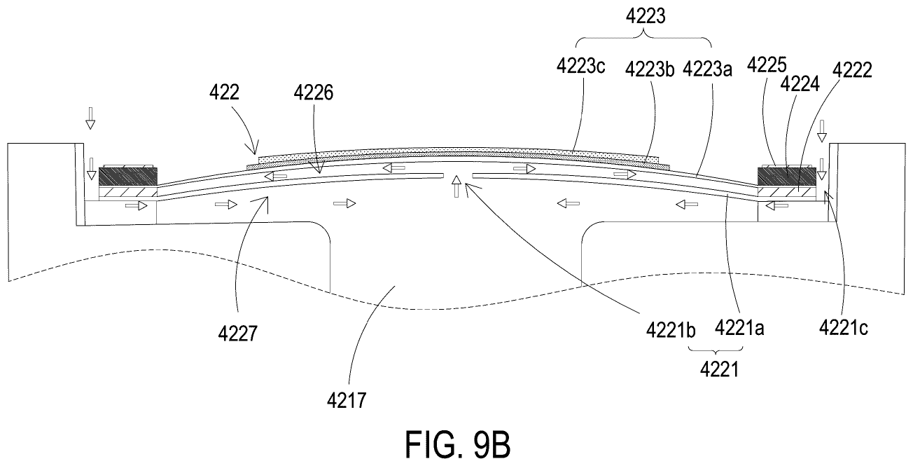

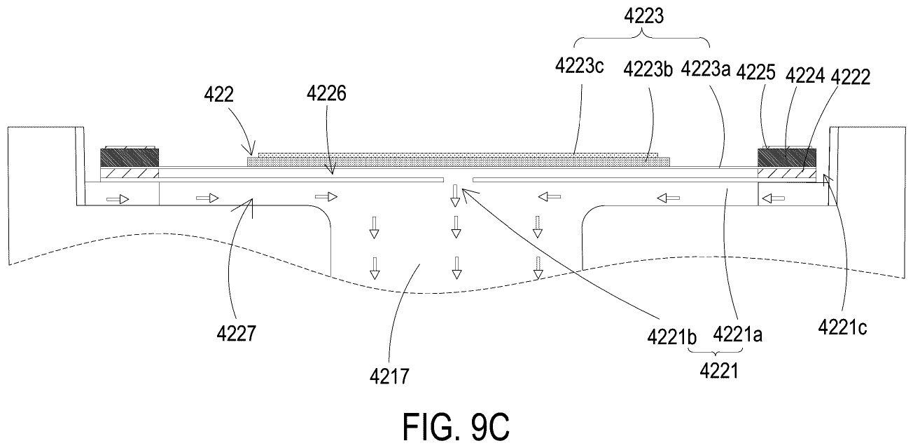

By repeating the above operation steps shown in FIG. 9B and FIG. 9C, the piezoelectric plate 4223c is driven to generate the bending deformation in a reciprocating manner. According to the principle of inertia, since the gas pressure inside the resonance chamber 4226 is lower than the equilibrium gas pressure after the converged gas is ejected out, the gas is introduced into the resonance chamber 4226 again. Moreover, the vibration frequency of the gas in the resonance chamber 4226 is controlled to be close to the vibration frequency of the piezoelectric plate 4223c, so as to generate the Helmholtz resonance effect to achieve the gas transportation at high speed and in large quantities.

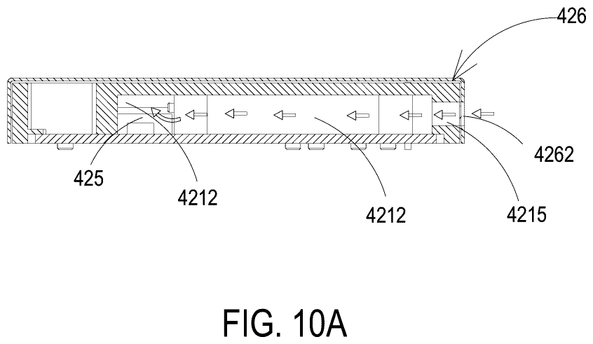

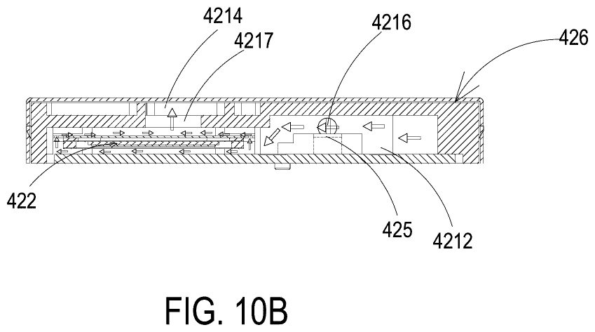

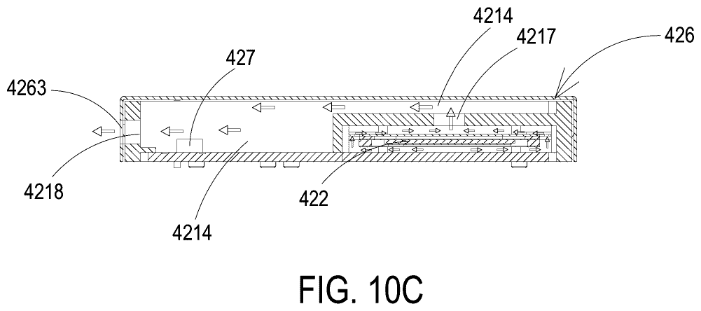

Please refer to FIG. 10A to FIG. 10C. The gas is inhaled through the gas-inlet 4262 on the outer cover 426, flows into the gas-inlet groove 4212 of the base 421 through the gas-inlet 4215, and is transported to the position of the particulate sensor 425. In addition, the piezoelectric actuator 422 is enabled continuously to inhale the gas into the inlet path, and facilitate the gas outside the gas detection module to be introduced rapidly, flow stably, and transported above the particulate sensor 425. At this time, a projecting light beam emitted from the laser component 424 passes through the transparent window 4216 to irritate the suspended particles contained in the gas flowing above the particulate sensor 425 in the gas-inlet groove 4212. When the suspended particles contained in the gas are irradiated and generate scattered light spots, the scattered light spots are received and calculated by the particulate sensor 425 for obtaining related information about the sizes and the concentration of the suspended particles contained in the gas. Moreover, the gas above the particulate sensor 425 is continuously driven and transported by the piezoelectric actuator 422, flows into the ventilation hole 4217 of the gas-guiding-component loading region 4213, and is transported to the gas-outlet groove 4214. At last, after the gas flows into the gas outlet groove 4214, the gas is continuously transported into the gas-outlet groove 4214 by the piezoelectric actuator 422, and thus the gas in the gas-outlet groove 4214 is pushed to discharge through the gas-outlet 4218a and the outlet opening 4263, to achieve the gas transportation at high speed and in large quantities.

Notably, in the above embodiment, the air pollution is at least one selected from the group consisting of particulate matter, carbon monoxide, carbon dioxide, ozone, sulfur dioxide, nitrogen dioxide, lead, total volatile organic compounds (TVOC), formaldehyde, bacteria, fungi, virus and a combination thereof. The IoT communication is a wireless communication for communicating with the networked cloud computing service device 5 through a wireless connection. Preferably but not exclusively, the wireless communication is one selected from the group consisting of a Wi-Fi communication, a Bluetooth communication, a radio frequency identification communication and a near field communication (NFC). Alternatively, the IoT communication is a wired communication for connecting and communicating with the networked cloud computing service device 5 through a wired line connection. In the embodiment, the air guiding fan 2 includes an exhaust volume greater than 20 m³/min, and a wind pressure greater than 30 mmAq. Preferably but not exclusively, the air guiding fan 2 includes the exhaust volume ranged from 30 m³/min to 120 m³/min, and the wind pressure ranged from 50 mmAq to 200 mmAq. Preferably, the air guiding fan 2 includes an optimal exhaust volume of 50 m³/min, and the wind pressure of 180 mmAq.

Please refer to FIG. 1D. In the embodiment, the intelligent networked range hood of the present disclosure further comprises two deflectors 14 arranged in the two sides of the main body 1, and each of the deflectors 14 comprises an extended baffle 14a. As shown in FIG. 1D, in this embodiment, each extended baffle 14a is pivotally connected to the corresponding deflector 4, and can be unfolded and erected on the two sides of the main body 11 (as shown by the allows). In other embodiments, as shown in FIG. 1E, the extended baffles 14a are extended downward from the inside of the deflectors 14 (as shown by the arrows), wherein the deflectors 14 and the extended baffles 14a are erected on the two sides of the main body 11. In above embodiments, the air hood frame 13 is disposed around the cooking area K. When the air pollution of oil smoke is generated during cooking in the cooking area K, through the collaborations of the upward air flow with pressure around the cooking area K generated from the air hood frame 13, and the two deflectors 14 and the two extended baffles 14a arranged in the two sides of the main body 1, the air pollution can be blocked in the cooking area K without spreading, and is concentrated to the duct 12 by passing through the air guiding path. Finally, the air pollution is discharged to the outdoor field through the guiding fan 2, so that the air pollution is purified and completely cleaned.

Please refer to FIG. 1F. In some embodiments, the deflectors 14 of the intelligent networked range hood are arranged in the two sides of the main body 1. The deflector 14 further comprises an extended baffle 14a, the extended baffle 14a is a U-shaped cover, but not limited thereto. The U-shaped cover of the extended baffle 14a can be pulled forward to extend or to be retracted backward. As shown in FIG. 1F, the extended baffle 14a is pulled forward and deployed to cover around the cooking area K (as shown by the arrows). When the air pollution of oil smoke is generated during cooking in the cooking area K, through the collaborations of the upward air flow with pressure around the cooking area K generated from the air hood frame 13, and the two deflectors 14 and the U-shaped cover of the extended baffle 14a covering around the cooking area K, the air pollution can be blocked in the cooking area K without spreading, and is concentrated to the duct 12 by passing through the air guiding path. Finally, the air pollution is discharged to the outdoor field through the guiding fan 2, so that the air pollution is purified and completely cleaned.

Please refer to FIG. 1G. In other embodiments, the deflectors 14 of the intelligent networked range hood are arranged in the two sides of the main body 1, which can extend forward and laterally. The deflector 14 comprises an extended baffle 14a, which is a moveable U-shaped cover and can also be pulled forward and sideways. As shown in FIG. 1G, the deflectors 14 is pulled forward, and the moveable U-shaped cover of the extended baffle 14a is also pulled forward and laterally (as shown by the arrows), which are deployed to cover around the cooking area K. When the air pollution of oil smoke is generated during cooking in the cooking area K, through the collaborations of the upward air flow with pressure around the cooking area K generated from the air hood frame 13, and the two deflectors 14 and the moveable U-shaped cover of the extended baffle 14a covering around the cooking area K, the air pollution can be blocked in the cooking area K without spreading, and is concentrated to the duct 12 by passing through the air guiding path. Finally, the air pollution is discharged to the outdoor field through the guiding fan 2, so that the air pollution is purified and completely cleaned.

In some embodiments, as shown in FIG. 1B, FIG. 1D, and FIG. 1E, the intelligent networked range hood of the present disclosure further comprises an electrostatic oil fume separator 6 arranged in the duct 12. The electrostatic oil fume separator 6 is used to separate the passing air pollution into oil droplets and smoke, the oil droplets is collected and the smoke is guided to the duct 12, and then discharged to the outdoor field by the air guiding fan 2. In other embodiments, as shown in FIG. 1B, FIG. 1D, and FIG. 1E, a filtering component 7 is disposed in the duct 12, but not limited thereto. As shown in FIG. 1H, the air guiding fan 2 is disposed in the duct 12 and maintained a sound insulation distance from the air suction port 11, and covered with a sound insulation material to reduce noise generated by the air guiding fan 2.

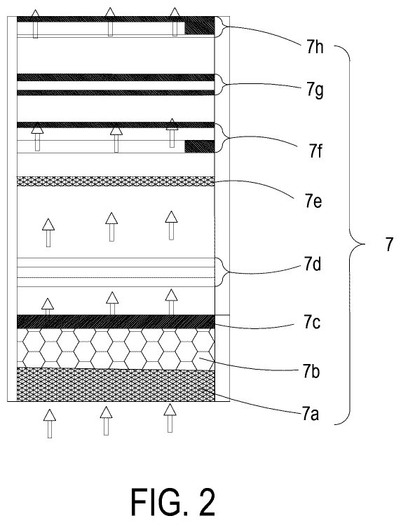

Please refer to FIG. 2. The filtering component 7 of the present disclosure can be a combination of various implementation forms. Preferably but not exclusively, in an embodiment, the filtering component 7 is a filter screen 7a, and the filter screen 7a is a filter screen with a minimum filtration efficiency value (MREV) equal to or greater than level 8. In an embodiment, the filtering component 7 is a filter screen 7a, and the filter screen 7a is a high-efficiency particulate air(HEPA) filter screen grade, which is configured to absorb the chemical smoke, the bacteria, the dust particles and the pollen contained in the air pollution, so that the air pollution introduced is filtered and purified to achieve the effect of filtering and purification. Notably, in the present disclosure, the high-efficiency particulate air (HEPA) filter screen is equal to or greater than a high-efficiency particulate air filter (HEPA) grade 10, with a dust holding capacity greater than 12,000 mg. Alternatively, the filter screen 7a is a ULPA14 filter screen grade, so as to improve filtration efficiency and meet higher cleanliness requirements. In some specific embodiments, the filtering component 7 is further combined with physical or chemical materials to provide a sterilization effect for air pollution passing therethrough, and the airflow path direction of the air guiding fan 2 is the direction shown by the arrow. In an embodiment, the filtering component 7 is combined with a decomposition layer coated thereon to clean the air pollution through a chemical method of sterilization. Preferably but not exclusively, the decomposition layer is an activated carbon 7b for cleaning organic and inorganic substances in air pollution, and removing colored and odorous substances. Notably, the activated carbon 7b has a formaldehyde absorption capacity greater than 1500 mg. Moreover, in some embodiments, the filtering component 7 is combined with a light irradiation element to clean the air pollution through a chemical method of sterilization. Preferably but not exclusively, the light irradiation element is a photo-catalyst unit including a photo catalyst 7c and an ultraviolet lamp 7d for further improving the removal efficiency of pollutants and allergens in the air. When the photo catalyst 7c is irradiated by the ultraviolet lamp 7d, the light energy is converted into the chemical energy, thereby decomposes harmful gases and disinfects bacteria contained in the air pollution, so as to achieve the effects of filtering and purifying. Notably, in the present disclosure, the ultraviolet lamp 7d has a power greater than 120 mW. In an embodiment, the light irradiation element is a photo-plasma unit including a nanometer irradiation tube 7e. When the introduced air pollution is irradiated by the nanometer irradiation tube 7e, the oxygen molecules and water molecules contained in the air pollution are decomposed into high oxidizing photo-plasma, and an ion flow capable of destroying organic molecules is generated. In that, volatile formaldehyde, volatile toluene and volatile organic compounds (VOC) contained in the air pollution are decomposed into water and carbon dioxide, so as to improve the removal efficiency of pollutants and allergens in the air, and achieve the effects of filtering and purifying. In some embodiments, the filtering component 7 is combined with a decomposition unit to clean the air pollution through a chemical method of sterilization. Preferably but not exclusively, the decomposition unit is a negative ion unit 7f with a dust collecting plate. It makes the suspended particles in the air pollution to carry with positive charge and adhered to the dust collecting plate carry with negative charges, so as to improve the removal efficiency of pollutants and allergens in the air, and achieve the effects of filtering and purifying. Preferably but not exclusively, the decomposition unit is a plasma ion unit 7g. The oxygen molecules and water molecules contained in the air pollution are decomposed into positive hydrogen ions (H⁺) and negative oxygen ions (O²⁻) by the plasma ion. The substances attached with water around the ions are adhered on the surface of viruses and bacteria and converted into OH radicals with extremely strong oxidizing power, thereby removing hydrogen (H) from the protein on the surface of viruses and bacteria, and thus decomposing (oxidizing) the protein, so as to improve the removal efficiency of pollutants and allergens in the air, and achieve the effects of filtering and purifying. Preferably but not exclusively, the decomposition unit is an electrostatic filtering unit 7h. The electrostatic force is used to capture and remove suspended particles (such as dust, pollen, bacteria and other pollutants) in the air.

From the above descriptions, the present disclosure provides an intelligent networked range hood, which includes the built-in gas detection module 4 with the cloud connection capabilities to implement real-time monitoring and adjustment. The intelligent networked range hood is further combined with the networked cloud computing service device 5 of the indoor air cleaning networked mechanism intelligent system, and has the following effects. For real-time monitoring and adjustment, the built-in gas detection module 4 can monitor the detection data of the humidity, temperature and the air pollution of indoor air in real time, and the detection data is transmitted to the Internet through IoT communication (wireless communication or wired communication). The cloud computing service device 5 regulates the activation operation of the air guiding fan 2 and dynamically adjusts the operating frequency and efficiency of the output air volume based on the collection and analysis of real-time monitoring detection data through the AI intelligent control platform 55. As the gas detection data is greater than the safety detection value, the output air volume of the air guiding fan 2 is adjusted to be larger, and the air guide fan 2 is automatically started to strengthen the purification mode. As the gas detection data is close to the safety detection value, the output air volume of the air guiding fan 2 is adjusted to be smaller. The oil smoke of the air pollution purification and completely cleaned procedure is to arrange the air hood frame 13, the deflectors 14 and the extended baffles 14a on the main body 1, so as to block the air pollution of cooking from spreading, and is concentrated to the duct 12 by passing through the air guiding path, and then discharged to the outdoor field through the guiding fan 2. Consequently, the air pollution is optimally purified and completely cleaned. The gas detection module 4 is an intelligent cloud connection with cloud connection capabilities. All air pollution detection data can be uploaded to the networked cloud computing service device 5, and the users can remotely check the air quality of the indoor environment. The filtering component 7 has multiple filtration technologies, and the filtering component 7 disposed in the duct 12 of the air guiding path of the intelligent networked range hood can be combined with activated carbon, high-efficiency filter, electrostatic filtration, photo catalyst unit, negative ion unit or plasma unit to achieve optimal filtration effects according to different pollution sources. When the indoor and outdoor environmental humidity is similar or the air quality reaches the standard, the networked cloud computing service device 5 will dynamically adjust the operating frequency of the air guiding fan 2 based on the collected and analyzed real-time monitoring detection data, automatically switch to a low energy consumption mode, and reduce the air volume noise. Even when the air quality in the indoor area is cleaned completely, the operation will be stopped to reduce unnecessary energy consumption.

In summary, the present disclosure provides an intelligent networked range hood, which includes a built-in gas detection module 4 for detecting air pollution in real time. In addition, the gas detection module 4 has cloud connection capabilities, which facilitates remote monitoring and operation by users. Moreover, the air pollution detection data is transmitted to a networked cloud computing service device 5 through IoT communication (wireless communication or wired communication), the networked cloud computing service device 5 intelligently selects a control command based on the collection and analysis of the detection data monitored real-time, and the control command is transmitted to the gas detection module 4 to control activation operation of the air guiding fan 2 and dynamically adjust the efficiency of operating frequency and output air volume of the air guiding fan 2. It can not only automatically adjust suction force, but also reduce unnecessary energy consumption. Furthermore, automation and optimization of operations are achieved, and the kitchen oil smoke is real-time purified and completely cleaned, and the indoor ambient air quality is regulated and maintained at the optimal state in a modern home environment. The present disclosure includes the industrial applicability and the inventive steps.

What is claimed is:

1. An intelligent networked range hood, comprising:
a main body comprising at least one air suction port and a duct, wherein the at least one air suction port is in communication with an air guiding path of the duct;
at least one air guiding fan disposed in the duct for guiding air pollution of a cooking area to the duct and discharging to the outdoor field;
at least one host driving controller controlling activation operation of the at least one air guiding fan, and dynamically adjusting an operating frequency and an output air volume of the at least one air guiding fan; and
at least one gas detection module electrically connected to the at least one host driving controller and detected a humidity, a temperature and the air pollution in the air to output a detection data, and transmitted the detection data to a networked cloud computing service device through IoT communication,
wherein the networked cloud computing service device adjusts and controls the at least one host driving controller in real time to regulates the activation operation of the at least one air guiding fan and dynamically adjusts the operating frequency and the output air volume of the at least one air guiding fan according to the detection data.

2. The intelligent networked range hood according to claim 1, wherein the air pollution is at least one selected from the group consisting of particulate matter, carbon monoxide, carbon dioxide, ozone, sulfur dioxide, nitrogen dioxide, lead, total volatile organic compounds (TVOC), formaldehyde, bacteria, fungi, virus and a combination thereof.

3. The intelligent networked range hood according to claim 1, wherein the number of the at least one air suction port is two, one is disposed on a lateral side of the main body against a wall, another is disposed on a surface of a top of the main body, and both of them are in communication with the duct, and a distance between the air suction port of the lateral side of the main body and a pot of the cooking area is ranged from 20 cm to 30 cm, so that the air pollution in the cooking area is guided to the duct through the at least one air guiding fan and discharged to the outdoor field.

4. The intelligent networked range hood according to claim 1, wherein the at least one air suction port is disposed on a lateral side of the main body against a wall and is in communication with the duct, and a distance between the at least one air suction port and a pot of the cooking area is ranged from 20 cm to 30 cm, or a top surface of the main body is also provided the at least one air suction port communicated with the duct, so that the air pollution in the cooking area is guided to the duct through the at least one air guiding fan and discharged to the outdoor field.

5. The intelligent networked range hood according to claim 1, wherein the at least one air guiding fan includes an exhaust volume greater than 20 m³/min, and a wind pressure greater than 30 mmAq, or the exhaust volume is ranged from 30 m³/min to 120 m³/min, and the wind pressure is ranged from 50 mmAq to 200 mmAq, or the exhaust volume is 50 m³/min, and the wind pressure is 180 mmAq.

6. The intelligent networked range hood according to claim 1, further comprising an air hood frame disposed around the cooking area, wherein the air hood frame is activated by the at least one host driving controller to generate an upward air flow with pressure around the cooking area, so that the air pollution of cooking is blocked in the cooking area without spreading, and is concentrated into the duct by passing through the air guiding path, and then discharged to the outdoor field.

7. The intelligent networked range hood according to claim 6, wherein an air guiding passage is disposed in the air hood frame, and a fan is arranged in the air guiding passage to introduce an external gas, and a plurality of fumaroles are disposed above the air guiding passage, when the fan is activated, the gas in the air guiding passage is discharged through the plurality of fumaroles to generate the upward airflow with pressure around the cooking area, wherein the air pollution of cooking is blocked in the cooking area without spreading, and is concentrated to the duct by passing through the air guiding path, and then discharged to the outdoor field through the fan, so that the air pollution is purified and completely cleaned.

8. The intelligent networked range hood according to claim 1, further comprising an electrostatic oil fume separator arranged in the duct and two deflectors arranged in the two sides of the main body, wherein the electrostatic oil fume separator is used to separate the passing air pollution into oil droplets and smoke, the oil droplets is collected and the smoke is guided to the duct, when the at least one air guiding fan is activated, the air pollution is blocked by the two deflectors without spreading, and is concentrated to the duct by passing through the air guiding path, and then discharged to the outdoor field, so that the air pollution is purified and completely cleaned.

9. The intelligent networked range hood according to claim 8, wherein each of the deflectors comprises an extended baffle, the extended baffle is extended downward from the inside of the deflector, or the extended baffle is pivotally connected to the deflector and can be unfolded and erected on the two sides of the main body, wherein the air pollution is blocked without spreading, and is concentrated to the duct by passing through the air guiding path, and then discharged to the outdoor field, so that the air pollution is purified and completely cleaned.

10. The intelligent networked range hood according to claim 8, wherein the deflectors comprise an extended baffle, the extended baffle is a U-shaped cover, and can be pulled forward and deployed to cover around the cooking area, or the extended baffle is a moveable U-shaped cover, and can be pulled forward and laterally to cover around the cooking area, wherein the air pollution is blocked without drifting away and concentrated to the duct by passing through the air guiding path, and discharged to the outdoor field, so that the air pollution is purified and completely cleaned.

11. The intelligent networked range hood according to claim 1, wherein the at least one air guiding fan is disposed in the duct and maintained a sound insulation distance from the at least one air suction port, and covered with a sound insulation material to reduce noise generated by the at least one air guiding fan.

12. The intelligent networked range hood according to claim 1, wherein the IoT communication is a wireless communication for communicating with the networked cloud computing service device through a wireless connection, or a wired communication for communicating with the networked cloud computing service device through a wired connection, and the wireless communication is one selected from the group consisting of a Wi-Fi communication, a Bluetooth communication, a radio frequency identification communication and a near field communication (NFC).

13. The intelligent networked range hood according to claim 1, wherein the networked cloud computing service device comprises an AI intelligent control platform, and the AI intelligent control platform collects, analyzes and monitors the detection data in real time, intelligently selects and generates a control instruction, and transmits the control instruction to the at least one gas detection module for receiving, wherein the at least one host driving controller is used to control the activation operation of the at least one air guiding fan, and dynamically adjust the operating frequency and the output air volume of the at least one air guiding fan.

14. The intelligent networked range hood according to claim 1, wherein the at least one gas detection module comprises a gas detection main part and a controlling circuit board, the gas detection main part detects humidity, the temperature and the air pollution to generate the detection data, the controlling circuit board collects, calculates, analyzes and outputs the detection data to form a serial communication (IIC) signal for input, and the networked cloud computing service device receives and analyzes the detection data in real time to output a Universal Asynchronous Transceiver and Transceiver (UART) signal and a General Purpose Input and Output (GP I/O) signal for the at least one at least one host driving controller.

15. The intelligent networked range hood according to claim 14, wherein the controlling circuit board comprises:
a power conversion component, providing DC voltage division modulation to output a required DC voltage, wherein the required DC voltage is transmitted through at least one connection interface to the gas detection main part for actuation operation and to the host driving controller for actuation operation;
a microcontroller (MCU), connected to the gas detection main part through the at least one connection interface to form the serial communication (IIC) signal for input, so that the detection data is calculated and analyzed, and connected through the at least one connection interface to output the Universal Asynchronous Transceiver and Transceiver (UART) signal and the General Purpose Input and Output (GP I/O) signal for regulation; and
a wireless communicator, receiving the detection data and transmitting to the networked cloud computing service device through external wireless communication, wherein the networked cloud computing service device collects, analyzes and monitors the detection data in real time and intelligently selects a control command, and the control command is received through the wireless communicator and transmitted to the microcontroller (MCU) to output the Universal Asynchronous Transceiver and Transceiver (UART) signal and the General Purpose Input and Output (GP I/O) signal for regulation of the at least one host driving controller, so that the at least one host driving controller is regulated to control the activation operation of the at least one air guiding fan, and dynamically adjust the operating frequency and the output air volume of the at least one air guiding fan.

16. The intelligent networked range hood according to claim 15, further comprising a wired communication port, wherein the wired communication port is electrically connected to the controlling circuit board through a connection interface for external connection to a wired communication transmission, wherein the detection data is received and transmitted to the networked cloud computing service device through external wireless communication, the networked cloud computing service device collects, analyzes and monitors the detection data in real time and intelligently selects a control command, and the control command is received through the wired communication port and transmitted to the microcontroller (MCU) to output the Universal Asynchronous Transceiver and Transceiver (UART) signal and the General Purpose Input and Output (GP I/O) signal for regulation of the at least one host driving controller, so that the at least one host driving controller is regulated to control the activation operation of the at least one air guiding fan, and dynamically adjust the operating frequency and the output air volume of the at least one air guiding fan, wherein the wired communication port is an RS485 port that communicates with the networked cloud computing service device through a wired line connection.

17. The intelligent networked range hood according to claim 14, wherein the gas detection main part comprises:
a base comprising a laser loading region, a gas-inlet groove, a gas-guiding-component loading region and a gas-outlet groove, wherein the gas-inlet groove comprises a gas-inlet and two lateral walls, the gas-inlet is in communication with an environment outside the base, and a transparent window is opened on the two lateral walls and is in communication with the laser loading region, the gas-guiding-component loading region is in communication with the gas-inlet groove, and a ventilation hole penetrates a bottom surface of the gas-guiding-component loading region, wherein the gas-outlet groove is in communication with the ventilation hole, and a gas-outlet is disposed in the gas-outlet groove;
a piezoelectric actuator accommodated in the gas-guiding-component loading region;
a driving circuit board covering and attached to the base;
a laser component positioned and disposed on the driving circuit board, electrically connected to the driving circuit board, and accommodated in the laser loading region, wherein a light beam path emitted from the laser component passes through the transparent window and extends in a direction perpendicular to the gas-inlet groove, thereby forming an orthogonal direction with the gas-inlet groove;
a particulate sensor positioned and disposed on the driving circuit board, electrically connected to the driving circuit board, and disposed at an orthogonal position where the gas-inlet groove intersects the light beam path of the laser component in the orthogonal direction, so that suspended particles contained in the air pollution passing through the gas-inlet groove and irradiated by a projecting light beam emitted from the laser component are detected;
at least one gas sensor positioned and disposed on the driving circuit board, electrically connected to the driving circuit board, and accommodated in the gas-outlet groove, so as to detect the air pollution introduced into the gas-outlet groove; and
an outer cover covering the base and comprising a side plate, wherein the side plate has an inlet opening and an outlet opening, the inlet opening is spatially corresponding to the gas-inlet of the base, and the outlet opening is spatially corresponding to the gas-outlet of the base;
wherein the outer cover covers the base, and the driving circuit board is attached to the base, thereby an inlet path is defined by the gas-inlet groove, and an outlet path is defined by the gas-outlet groove, so that the air pollution is inhaled from the environment outside the base by the piezoelectric actuator, transported into the inlet path defined by the gas-inlet groove through the inlet opening, and passes through the particulate sensor to detect the particle concentration of the suspended particles contained in the air pollution, and the air pollution transported through the piezoelectric actuator is transported out of the outlet path defined by the gas-outlet groove through the ventilation hole, passes through the gas sensor for detecting, and then discharged from the gas-outlet of the base through the outlet opening.

18. The intelligent networked range hood according to claim 17, wherein the laser component emits a parallel light source, and the parallel light source passes through the transparent window, wherein the particulate sensor detects suspended particulate and outputs the detection data, and the at least one gas sensor comprises a temperature and humidity sensor, and the temperature and humidity sensor detects the temperature and humidity in air to output the detection data, wherein the at least one gas sensor comprises a volatile-organic-compound sensor, and the volatile-organic-compound sensor detects gas of carbon dioxide (CO₂) or volatile organic compounds (TVOC) to output the detection data, and the formaldehyde sensor detects gas of formaldehyde (HCHO) to output the detection data, wherein the at least one gas sensor comprises a bacteria sensor, and the bacteria sensor detects gas information of bacteria or fungi to output the detection data, wherein the at least one gas sensor comprises wherein the at least one gas sensor comprises a virus sensor, and the virus sensor detects gas of virus to output the detection data.

19. The intelligent networked range hood according to claim 1, further comprising a filtering component disposed in the duct, wherein the filtering component is a filter screen, and the filter screen is at least one selected from the group consisting of a filter screen with a minimum filtration efficiency value (MREV) equal to or greater than level 8, a high-efficiency particulate air (HEPA) filter screen grade, and a ULPA14 filter screen grade, wherein the high-efficiency particulate air(HEPA) filter screen is equal to or greater than a high-efficiency particulate air filter (HEPA) grade 10, with a dust holding capacity greater than 12,000 mg.

20. The intelligent networked range hood according to claim 19, wherein the filtering component is combined with a chemical decomposition layer coated thereon, the filtering component is combined with a light irradiation element, or the filtering component is combined with a decomposition unit to clean the air pollution through a chemical method of sterilization, wherein the decomposition layer is at least one selected from the group consisting of an activated carbon, a negative ion unit, a plasma ion unit, and an electrostatic filtering unit, wherein the activated carbon has a formaldehyde absorption capacity greater than 1500 mg, wherein the light irradiation element is a photo-catalyst unit including a photo catalyst and an ultraviolet lamp, or a photo-plasma unit including a nanometer irradiation tube, wherein the ultraviolet lamp has a power greater than 120 mW.
